(19) United States
(12) Patent Application Publication
(10) Pub. No.: US 2020/0209134 A1
(43) Pub. Date: Jul. 2, 2020

(54) PARTICLE DETECTION ELEMENT AND PARTICLE DETECTOR

(71) Applicant: NGK INSULATORS, LTD., Nagoya-City (JP)

(72) Inventors: KEIICHI KANNO, Nagoya-City (JP); Kazuyuki Mizuno, Nagoya-City (JP); Hidemasa Okumura, Nagoya-City (JP)

(73) Assignee: NGK INSULATORS, LTD., Nagoya-City (JP)

(21) Appl. No.: 16/807,337

(22) Filed: Mar. 3, 2020

Related U.S. Application Data
(63) Continuation of application No. PCT/JP2018/029057, filed on Aug. 2, 2018.

(30) Foreign Application Priority Data
Sep. 6, 2017 (JP) 2017-171122

(51) Int. Cl. G01N 15/06; B03C 3/41; B03C 3/82

(52) U.S. Cl. CPC G01N 15/0606; G01N 15/0656; B03C 3/82; B03C 3/41

(57) ABSTRACT

A particle detection element used to detect the number of particles in a gas includes: a casing having a gas flow passage through which the gas passes; an electric charge generating unit that imparts charges generated by a discharge to the particles in the gas introduced into the casing to thereby form charged particles; and a collecting unit including a collecting electrode that is disposed inside the casing and collects a collection target that is the charged particles or the charges not imparted to the particles. The casing has a reinforcing portion on at least one of an outer circumferential surface and an inner circumferential surface of the casing, and the reinforcing portion partially thickens a wall of the gas flow passage.

### BACKGROUND OF THE INVENTION

### 1. Field of the Invention

The present invention relates to a particle detection element and to a particle detector.

### 2. Description of the Related Art

One known conventional particle detector includes: an electric charge generating element that imparts charges generated by a corona discharge to particles in a measurement gas introduced into a casing; and a measurement electrode that collects the charged particles (for example, PTL 1). In this particle detector, the number of particles is measured based on the amount of charges on the particles collected by the measurement electrode.

### CITATION LIST

### Patent Literature

PTL 1: International Publication No. WO2015/146456

### SUMMARY OF THE INVENTION

In the above particle detector, the casing may deform due to an external force or thermal shock that occurs when water adheres to the casing. The deformation of the casing may cause the electric field distribution during discharge of the electric charge generator to be changed, and the number of charges generated and the spatial distribution of the charges may be changed. In this case, the number of charges adhering to one particle may be changed, so that the accuracy of measurement may be reduced.

The present invention has been made to solve the foregoing problem, and a principal object of the invention is to suppress the deformation of the casing.

To achieve the above principal object, the present invention adopts the following measures.

A particle detection element of the present invention is used to detect particles in a gas, the particle detection element includes:

a casing having a gas flow passage through which the gas passes;

an electric charge generating unit that imparts charges generated by a discharge to the particles in the gas introduced into the casing to thereby form charged particles; and

a collecting unit including a collecting electrode that is disposed inside the casing and collects a collection target that is the charged particles or the charges not imparted to the particles,

wherein the casing includes a reinforcing portion on at least one of an outer circumferential surface and an inner circumferential surface of the casing, the reinforcing portion partially thickening a wall of the gas flow passage.

In this particle detection element, the electric charge generating unit generates electric charges to thereby convert particles in the gas into charged particles, and the collecting electrode collects the collection target (the charged particles or the charges not imparted to the particles). Since a physical quantity varies according to the collection target collected by the collecting electrode, the use of the particle detection element allows the particles in the gas to be detected. Since the casing includes the reinforcing portion on at least one of the outer circumferential surface and the inner circumferential surface, the stiffness of the casing is increased, and the deformation of the casing is suppressed. When the casing deforms, the distribution of the electric field in the gas flow passage during discharge of the electric charge generating unit may be changed, and the accuracy of detection of particles may be reduced. By suppressing the deformation of the casing, a reduction in the detection accuracy can be prevented. In this case, the particle detection element of the present invention may be used to detect the amount of the particles in the gas. The “amount of the particles” may be, for example, at least one of the number, mass, and surface area of the particles.

In the particle detection element of the present invention, the casing may include a partition that partitions the gas flow passage into a plurality of branched flow passages, and the collecting unit may include a plurality of the collecting electrodes disposed in the respective branched flow passages. In this case, since the partition serves as a support member that supports the casing from the inside, the deformation of the casing can be more effectively suppressed by the reinforcing portion and the partition.

In the particle detection element of the present invention, the casing may include a heater electrode that is embedded in the casing and heats the casing, and the reinforcing portion may be disposed such that a portion of the wall in which the heater electrode is embedded is partially thickened. In this case, by causing the heater electrode to generate heat, particles adhering to, for example, the inner circumferential surface of the casing and the collecting electrode can be burnt, and the particle detection element can be refreshed. Since the reinforcing portion is disposed so as to thicken the portion of the wall in which the heater electrode is embedded, the heat capacity of a portion of the casing around the heater electrode is large. Therefore, a change in temperature of the heater electrode due to a fluid in contact with the casing can be reduced.

In the particle detection element of the present invention, the reinforcing portion may be disposed on the inner circumferential surface of the casing, and a cross section obtained by cutting the inner circumferential surface in a direction perpendicular to a center axis of the gas flow passage may have a rectangular shape in which a corner of the rectangular shape is reinforced due to the presence of the reinforcing portion. Stress tends to be concentrated on the corner of the inner circumferential surface of the casing. However, in the above case, the corner is reinforced, and therefore the deformation of the casing can be more effectively suppressed. The phrase “the rectangular shape in which a corner of the rectangular shape is reinforced” is meant to include the case where the cross section of the inner circumferential surface of the casing has a pentagonal or higher polygonal shape (e.g., one of pentagonal to octagonal shapes) due to the presence of the reinforcing portion and the case where a corner of the rectangular shape is rounded due to the presence of the reinforcing portion.

In the particle detection element of the present invention, the wall of the casing may include: a long wall portion in which a portion of the inner circumferential surface that appears in a cross section perpendicular to a center axis of the gas flow passage has a long length; and a short wall portion in which a portion of the inner circumferential surface that appears in the cross section has a short length, and the reinforcing portion may be disposed on the long wall portion. Since the long wall portion is more likely to deform than the short wall portion, the presence of the reinforcing portion on the long wall portion can suppress the deformation of the casing more effectively.

In the particle detection element of the present invention, the collecting unit may include an electric field generating electrode that generates an electric field that causes the collection target to move toward the collecting electrode. In this case, the collecting electrode can collect the collection target in a more reliable manner. In the particle detection element of the present invention in which the casing includes the partition, the collecting electrode and the electric field generating electrode may form a pair of electrodes, and the collecting unit includes a plurality of the pairs of electrodes disposed in the respective branched flow passages.

The particle detector of the present invention includes: the particle detection element according to any one of the above modes; and a detection unit that detects the particles based on a physical quantity that varies according to the collection target collected by the collecting electrode. Therefore, this particle detector has the same effects as those of the particle detection element of the present invention described above. For example, one of the effects is that the deformation of the casing can be suppressed. In this case, the detection unit may detect the amount of the particles based on the physical quantity. The “amount of the particles” may be, for example, at least one of the number, mass, and surface area of the particles. In this particle detector, when the collection target is charges not imparted to the particles, the detection unit may detect the particles based on the physical quantity and the charges (e.g., the number of charges or the amount of charges) generated by the electric charge generating unit.

In the present description, the “charges” are meant to include positive charges, negative charges, and ions. The phrase “to detect the amount of particles” is meant to include the case where the amount of particles is measured and the case where whether or not the amount of particles falls within a prescribed numerical range is judged (whether or not the amount of particles exceeds a prescribed threshold value is judged). The “physical quantity” may be any parameter that varies according to the number of collection target objects (the amount of charges) and is, for example, an electric current.

### BRIEF DESCRIPTION OF THE DRAWINGS

FIG. 1 is a perspective view showing a schematic structure of a particle detector 10.

FIG. 2 is an A-A cross-sectional view of FIG. 1.

FIG. 3 is a partial cross-sectional view of a B-B cross section of FIG. 1.

FIG. 4 is an illustration when the particle detector 10 is viewed from C in FIG. 1, i.e., a (partial) bottom view of a casing 12.

FIG. 5 is an exploded perspective view of a particle detection element 11.

FIG. 6 is a partial cross-sectional view of a casing 112 in a modification.

FIG. 7 is a partial cross-sectional view of a casing 112 in another modification.

FIG. 8 is a partial cross-sectional view of a casing 112 in another modification.

FIG. 9 is a partial cross-sectional view of a casing 212 in another modification.

FIG. 10 is a cross-sectional view of a particle detector 710 in another modification.

### DETAILED DESCRIPTION OF THE INVENTION

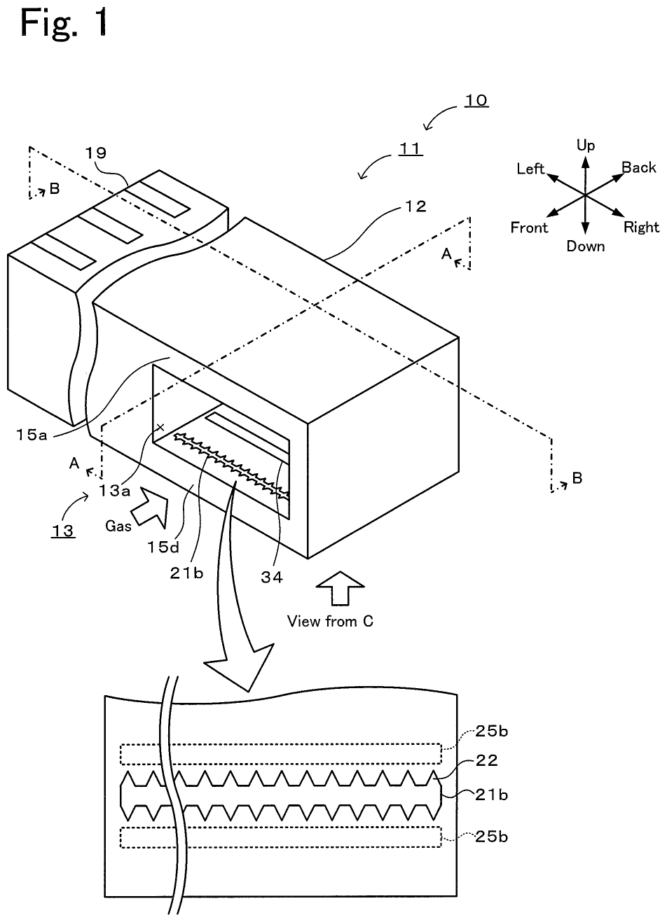

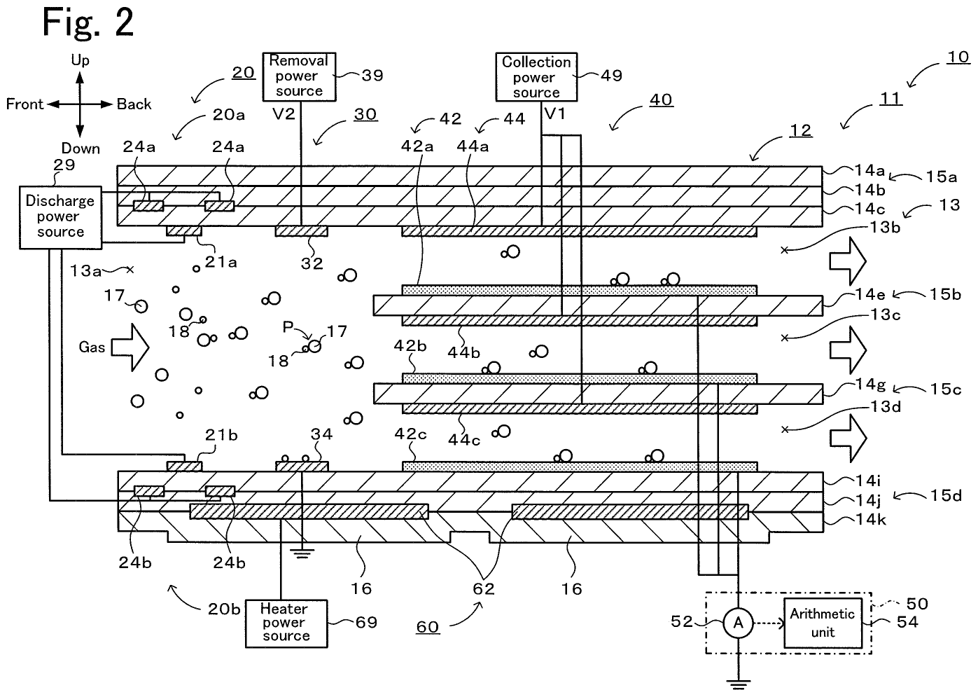

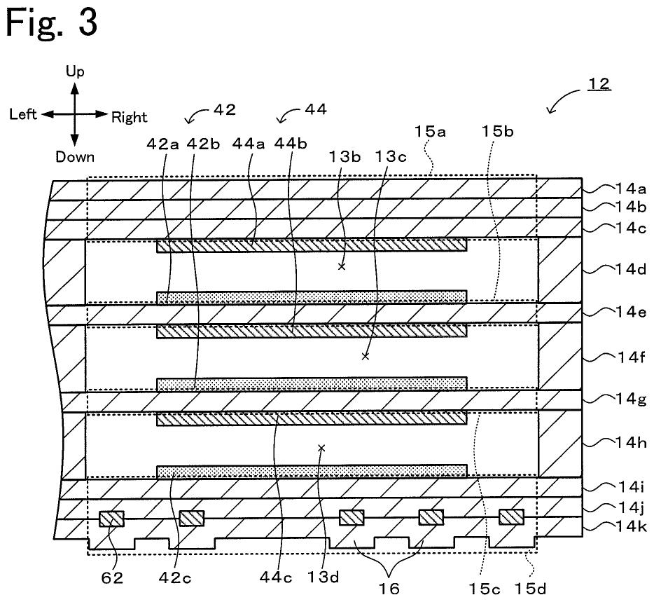

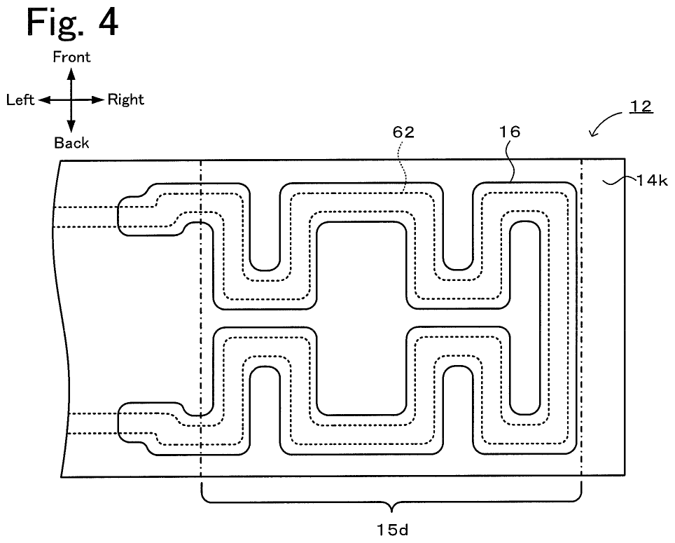

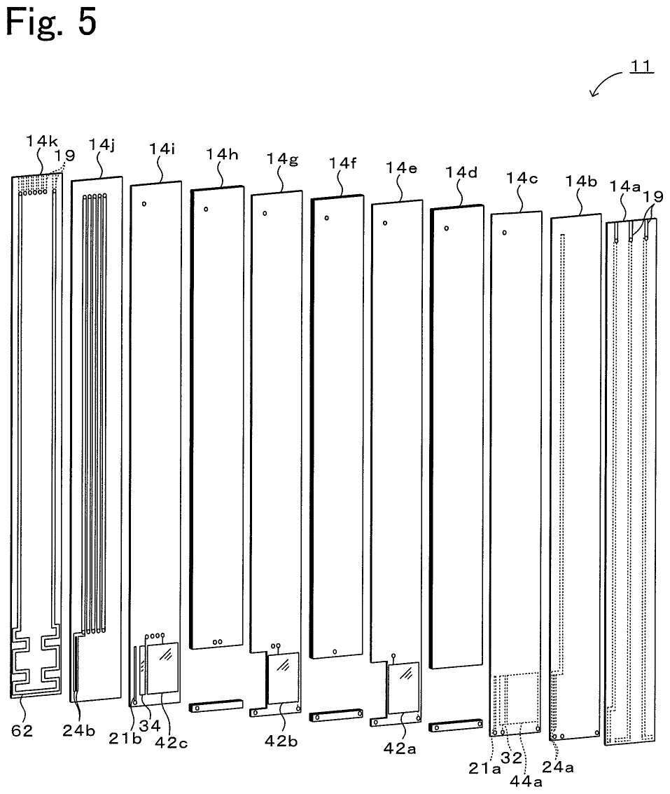

Next, an embodiment of the present invention will be described with reference to the drawings. FIG. 1 is a perspective view showing a schematic structure of a particle detector 10 that is an embodiment of the present invention. FIG. 2 is an A-A cross-sectional view of FIG. 1, and FIG. 3 is a partial cross-sectional view of a B-B cross section of FIG. 1. FIG. 4 is an illustration when the particle detector 10 is viewed from C in FIG. 1, i.e., a (partial) bottom view of a casing 12, and FIG. 5 is an exploded perspective view of a particle detection element 11. In the present embodiment, upward and downward directions, left and right directions, and forward and backward directions are as shown in FIGS. 1 to 4.

The particle detector 10 counts the number of particles 17 contained in a gas (for example, exhaust gas from an automobile). As shown in FIGS. 1 and 2, the particle detector 10 includes the particle detection element 11. As shown in FIG. 2, the particle detector 10 includes a discharge power source 29, a removal power source 39, a collection power source 49, a detector 50, and a heater power source 69. As shown in FIG. 2, the particle detection element 11 includes a casing 12, an electric charge generator 20, an excess electric charge removing unit 30, a collector 40, and a heater 60.

The casing 12 has therein a gas flow passage 13 through which gas passes. As shown in FIG. 2, the gas flow passage 13 includes: a gas inlet 13a for introducing the gas into the casing 12; and a plurality of (three in this case) branched flow passages 13b to 13d which are located downstream of the gas introduction port 13a and through which branched gas flows pass. The gas introduced into the casing 12 from the gas inlet 13a is discharged from the casing 12 through the branched flow passages 13b to 13d. A cross section of the gas flow passage 13 that is perpendicular to the center axis of the gas flow passage 13 (a cross section in the vertical and left-right directions) has a substantially rectangular shape. Cross sections of the gas inlet 13a and the branched flow passages 13b to 13d that are perpendicular to the center axis of the gas flow passage 13 have a substantially rectangular shape. As shown in FIGS. 1 and 5, the casing 12 has an elongated substantially cuboidal shape. As shown in FIGS. 2,3 and 5, the casing 12 is formed as a layered body in which a plurality of layers (first to eleventh layers 14a to 14k in this case) are stacked in a prescribed stacking direction (a vertical direction in this case). The casing 12 is an insulator and is made of a ceramic such as alumina. Through holes or notches are provided in the fourth to eighth layers 14d to 14h so as to pass therethrough in their thickness direction (in the vertical direction in this case), and the through holes or the notches serve as the gas flow passage 13. As shown in FIG. 3, the fourth, sixth, and eighth layers 14d, 14f, and 14h form the side walls (the left and right walls in this case) of the branched flow passages 13b, 13c, and 13d, respectively. In the present embodiment, the fourth, sixth, and eighth layers 14d, 14f, and 14h are thicker than other layers. The fourth, sixth, and eighth layers 14d, 14f, and 14h may each be a layered body including a plurality of layers.

As shown in FIGS. 2 and 3, the casing 12 has first to fourth walls 15a to 15d that serve as walls of the gas flow passage 13. The first wall 15a includes portions of the first to third layers 14a to 14c that are located directly above the gas flow passage 13. The lower surface of the first wall 15a forms a ceiling surface of the gas flow passage 13. The first wall 15a is part of the upper outer wall of the casing 12. A discharge electrode 21a, an application electrode 32, and a first electric field generating electrode 44a are disposed on the lower surface of the first wall 15a. The second wall 15b includes a portion of the fifth layer 14e that faces the gas flow passage 13 (a portion located directly below the branched flow passage 13b and directly above the branched flow passage 13c). The second wall 15b is formed as a partition that vertically separates the branched flow passage 13b and the branched flow passage 13c from each other. A first collecting electrode 42a is disposed on the upper surface of the second wall 15b, and a second electric field generating electrode 44b is disposed on the lower surface. The third wall 15c includes a portion of the seventh layer 14g that faces the gas flow passage 13 (a portion located directly below the branched flow passage 13c and directly above the branched flow passage 13d). The third wall 15c is formed as a partition that vertically separates the branched flow passage 13c and the branched flow passage 13d from each other. A second collecting electrode 42b is disposed on the upper surface of the third wall 15c, and a third electric field generating electrode 44c is disposed on the lower surface. The fourth wall 15d includes portions of the ninth to eleventh layers 14i to 14k that are located directly below the gas flow passage 13. The upper surface of the fourth wall 15d forms the bottom surface of the gas flow passage 13. The fourth wall 15d is part of the lower outer wall of the casing 12. A discharge electrode 21b, a removing electrode 34, and a third collecting electrode 42c are disposed on the upper surface of the fourth wall 15d. As shown in FIGS. 2 to 4, the fourth wall 15d has a reinforcing portion 16 on the outer circumferential surface side (the lower side in this case) of the casing 12. The reinforcing portion 16 will be described later.

As shown in FIG. 3, the fourth, sixth, eighth layers 14d, 14f, and 14h in the casing 12 form side walls (left and right side walls in this case) of the branched flow passages 13b, 13c, and 13d, respectively. As described above, the cross sections of the branched flow passages 13b to 13d that are perpendicular to the center axis each have a substantially rectangular shape. In the present embodiment, the inner circumferential surfaces of the branched flow passages 13b to 13d that appear in these cross sections each have a substantially rectangular shape with its longitudinal direction parallel to the left-right direction. Therefore, in the branched flow passages 13b to 13d, the first to fourth walls 15a to 15d, which serve as the upper and lower walls, are long wall portions forming the long sides of the rectangular inner circumferential surfaces, and left and right walls are short wall portions forming the short sides of the rectangular inner circumferential surfaces. In a portion of the gas flow passage 13 other than the branched flow passages 13b to 13d, the fourth to eighth layers 14d to 14h of the casing 12 form the side walls (the left and right walls in this case). In the present embodiment, in the portion of the gas flow passage 13 other than the branched flow passages 13b to 13d (the portion forward of the branched flow passages 13b to 13d) also, the inner circumferential surface that appears in a cross section perpendicular to the center axis has a substantially rectangular shape with its left-right direction parallel to the longitudinal direction. Therefore, in the portion of the gas flow passage 13 other than the branched flow passages 13b to 13d, the first and fourth walls 15a and 15d serving as the upper and lower walls are long wall portions forming the long sides of the rectangular inner circumferential surface, and the left and right wall are short wall portions forming the short sides of the rectangular inner circumferential surface.

As shown in FIG. 2, the electric charge generator 20 includes first and second electric charge generators 20a and 20b disposed in the casing 12 on the side close to the gas inlet 13a. The first electric charge generator 20a includes the discharge electrode 21a disposed on the first wall 15a and ground electrodes 24a disposed in the first wall 15a. The discharge electrode 21a and the ground electrodes 24a are disposed on the front and back sides, respectively, of the third layer 14c serving as a dielectric layer. The discharge electrode 21a is disposed on the lower surface of the first wall 15a and exposed to the gas flow passage 13. The second electric charge generator 20b includes the discharge electrode 21b disposed on the fourth wall 15d and ground electrodes 24b disposed in the fourth wall 15d. The discharge electrode 21b and the ground electrodes 24b are disposed on the front and back sides, respectively, of the ninth layer 14i serving as a dielectric layer. The discharge electrode 21b is disposed on the upper surface of the fourth wall 15a and exposed to the gas flow passage 13. Each of the discharge electrodes 21a and 21b is formed from a rectangular thin metal plate with a plurality of fine triangular projections 22 on its opposed long sides (see FIG. 1). Each of the ground electrodes 24a and 24b is a rectangular electrode, and two ground electrodes 24a and two ground electrodes 24b are disposed parallel to the longitudinal direction of the discharge electrodes 21a and 21b. The discharge electrodes 21a and 21b and the ground electrodes 24a and 24b are connected to the discharge power source 29. The ground electrodes 24a and 24b are connected to the ground.

In the first electric charge generator 20a, when a high high-frequency voltage (e.g., a pulse voltage etc.) is applied between the discharge electrode 21a and the ground electrodes 24a from the discharge power source 29, an aerial discharge (dielectric barrier discharge in this case) occurs in the vicinity of the discharge electrode 21a due to the potential difference between the electrodes. Similarly, in the second electric charge generator 20b, an aerial discharge occurs in the vicinity of the discharge electrode 21b due to the potential difference between the discharge electrode 21b and the ground electrodes 24b caused by a high voltage from the discharge power source 29. Gas present around the discharge electrodes 21a and 21b is thereby ionized by these discharges, and charges 18 (positive charges in this case) are generated. The charges 18 are imparted to the particles 17 in the gas passing through the electric charge generator 20, and charged particles P are thereby formed (see FIG. 2).

Since the electric charge generator 20 generates charges 18 by a dielectric barrier discharge, the amount of charges 18 equivalent to the amount of charges 18 generated by a corona discharge using, for example, needle-shaped discharge electrodes can be obtained at a lower voltage and lower power consumption. Since the ground electrodes 24a and 24b are embedded in the casing 12, the ground electrodes 24a and 24b can be prevented from being short-circuited with other electrodes. Moreover, since the discharge electrodes 21a and 21b each have the plurality of projections 22, the charges 18 can be generated at a higher concentration. The discharge electrodes 21a and 21b are disposed along the inner circumferential surface of the casing 12 that is exposed to the gas flow passage 13. Therefore, the discharge electrodes 21a and 21b can be integrally formed with the casing more easily than when, for example, needle-shaped discharge electrodes are disposed so as to be exposed to the gas flow passage 13. Moreover, the discharge electrodes 21a and 21b are less likely to block the flow of the gas, and particles are less likely to adhere to the discharge electrodes 21a and 21b.

The excess electric charge removing unit 30 includes the application electrode 32 and the removing electrode 34. The application electrode 32 and the removing electrode 34 are located downstream of the electric charge generator 20 but upstream of the collector 40. The application electrode 32 is disposed on the lower surface of the first wall 15a and exposed to the gas flow passage 13. The removing electrode 34 is disposed on the upper surface of the fourth wall 15d and exposed to the gas flow passage 13. The application electrode 32 and the removing electrode 34 are disposed in positions facing each other. The application electrode 32 is an electrode to which a small positive potential V2 is applied from the removal power source 39. The removing electrode 34 is an electrode connected to the ground. In this case, a weak electric field is generated between the application electrode 32 and the removing electrode 34 of the excess electric charge removing unit 30. Therefore, among the charges 18 generated by the electric charge generator 20, excess charges 18 not imparted to the particles 17 are attracted to the removing electrode 34 by this weak electric field, captured by the removing electrode 34, and discarded to the ground. In this manner, the excess electric charge removing unit 30 prevents the excess charges 18 from being collected by the collecting electrodes 42 of the collector 40 and counted as the particles 17.

The collector 40 is a device for collecting a collection target (the charged particles P in this case) and is disposed in the branched flow passages 13b to 13d located downstream of the electric charge generator 20 and the excess electric charge removing unit 30. The collector 40 includes one or more collecting electrodes 42 for collecting the charged particles P and one or more electric field generating electrodes 44 for causing the charged particles P to move toward the collecting electrodes 42. In the present embodiment, the collector 40 includes first to third collecting electrodes 42a to 42c as the collecting electrodes 42 and first to third electric field generating electrodes 44a to 44c as the electric field generating electrodes 44. The collecting electrodes 42 and the electric field generating electrodes 44 are disposed so as to be exposed to the gas flow passage 13. The first collecting electrode 42a and the first electric field generating electrode 44a form a pair of electrodes. Similarly, the second collecting electrode 42b and the second electric field generating electrode 44b form a pair of electrodes, and the third collecting electrode 42c and the third electric field generating electrode 44c form a pair of electrodes. Specifically, the collector 40 includes a plurality of pairs (three pairs in this case) of electrodes. Each pair of electrodes (one collecting electrode 42 and one electric field generating electrode 44 forming a pair) are disposed at positions facing each other vertically. Each of the first to third electric field generating electrodes 44a to 44c generates an electric field that causes the charged particles P to move toward a corresponding one of the first to third collecting electrodes 42a to 42c. One pair of electrodes is disposed in each of the branched flow passage 13b to 13c. Specifically, the first electric field generating electrode 44a is disposed on the lower surface of the first wall 15a, and the first collecting electrode 42a is disposed on the upper surface of the second wall 15b. The second electric field generating electrode 44b is disposed on the lower surface of the second wall 15b, and the second collecting electrode 42b is disposed on the upper surface of the third wall 15c. The third electric field generating electrode 44c is disposed on the lower surface of the third wall 15c, and the third collecting electrode 42c is disposed on the upper surface of the fourth wall 15d.

A voltage V1 is applied from the collection power source 49 to the first to third electric field generating electrodes 44a to 44c. The first to third collecting electrodes 42a to 42c are each connected to the ground through an ammeter 52. In this case, an electric field directed from the first electric field generating electrode 44a toward the first collecting electrode 42a is generated in the branched flow passage 13b, and an electric field directed from the second electric field generating electrode 42b toward the second collecting electrode 42b is generated in the branched flow passage 13c. Moreover, an electric field directed from the third electric field generating electrode 44c toward the third collecting electrode 42c is generated in the branched flow passage 13d. Therefore, the charged particles P flowing through the gas flow passage 13 enter any of the branched flow passages 13b to 13d, are moved downward by the electric field generated therein, attracted to any of the first to third collecting electrodes 42a to 42c, and collected thereby. The voltage V1 is a positive potential, and the level of the voltage V1 is of the order of, for example, 100 V to several kV. The sizes of the electrodes 34 and 42 and the strengths of the electric fields (i.e., the magnitudes of the voltages V1 and V2) on the electrodes 34 and 42 are set such that the charged particles P are collected by the collecting electrodes 42 without being collected by the removing electrode 34 and that the charges 17 not adhering to the particles 17 are collected by the removing electrode 34.

The detector 50 includes the ammeter 52 and an arithmetic unit 54. One terminal of the ammeter 52 is connected to the collecting electrodes 42, and the other terminal is connected to the ground. The ammeter 52 measures a current based on the charges 18 on the charged particles P collected by the collecting electrodes 42. The arithmetic unit 54 computes the number of particles 17 based on the current measured by the ammeter 52. The arithmetic unit 54 may function as a control unit that controls the units 20, 30, 40, and 60 by controlling on/off of each of the power sources 29, 39, 49, and 69 and their voltages.

The heater 60 includes a heater electrode 62 disposed between the tenth layer 14j and the eleventh layer 14k and embedded mainly in the fourth wall 15d of the casing 12. As shown in FIG. 4, the heater electrode 62 is a band-shaped heating element routed in a zigzag pattern. In the present embodiment, the heater electrode 62 is routed over almost the entire region directly below the gas flow passage 13. The heater electrode 62 is connected to the heater power source 69 and generates heat when energized by the heater power source 69. The heater electrode 62 heats the casing 12 and electrodes such as the collecting electrodes 42. Preferably, the material of the heater electrode 62 has higher ductility than the material of the casing 12 (a ceramic in this case). Examples of the material of the heater electrode 62 include metals such as platinum and tungsten. The heater electrode 62 may be formed of at least one of them as a main component.

The reinforcing portion 16 included in the fourth wall 15d of the casing 12 will be described in detail. The reinforcing portion 16 is a member for reinforcing the casing 12 and is disposed on the outer circumferential surface (the lower surface in this case) of the casing 12, as shown in FIGS. 2 and 3. The reinforcing portion 16 is disposed on the fourth wall 15d, which is one of the above-described long wall portions in the walls of the casing 12. The reinforcing portion 16 is formed as a protruding portion that protrudes outward (downward in this case) from the fourth wall 15d. Therefore, in the fourth wall 15d, a portion in which the reinforcing portion 16 is present is partially thickened. As shown in FIG. 4, the reinforcing portion 16 is disposed along the heater electrode 62 so as to have a shape similar to the heater electrode 62 in a bottom view. Therefore, the reinforcing portion 16 is disposed so as to partially thicken the portion of the casing 12 in which the heater electrode 62 is embedded. The reinforcing portion 16 is present on the lower surface of the casing 12 in a portion directly below and around the heater electrode 62 and is formed into a band shape wider than the heater electrode 62 in a bottom view. Therefore, the reinforcing portion 16 is disposed so as to cover the heater electrode 62. The reinforcing portion 16 is formed integrally with the eleventh layer 14k as part of the eleventh layer 14k. As shown in FIG. 4, the reinforcing portion 16 on the lower surface of the casing 12 (the lower surface of the eleventh layer 14k in this case) may be present also on a portion other than the lower surface of the fourth wall 15d (the left portion of the lower surface of the fourth wall 15d in this case). The projecting height of the reinforcing portion 16 is larger than the difference in height between recesses and protrusions (the maximum height roughness Rz) that are caused by the surface roughness of the surface on which the reinforcing portion 16 is disposed (the lower surface of the fourth wall 15d in this case). Therefore, the reinforcing portion 16 can be distinguished from irregularities caused by the surface roughness. The projecting height of the reinforcing portion 16 may exceed, for example, 1.2 μm. The projecting height of the reinforcing portion 16 may be ¼ or less of the vertical thickness of the casing 12 (=the height of the casing 12). The projecting height of the reinforcing portion 16 may be 1 mm or less. In the course of firing when the casing 12 is produced, stress during thermal shrinkage caused by the difference in thickness between a portion of the fourth wall 15d in which the reinforcing portion 16 is present and a portion of the fourth wall 15d in which the reinforcing portion 16 is not present can be reduced when the projecting height is 1 mm or less. The projecting height of the reinforcing portion 16 may be larger than the thickness of the heater electrode 62. The maximum height roughness Rz of the surface on which the reinforcing portion 16 is disposed (the lower surface of the fourth wall 15d in this case) may be 1.2 μm or less. The surface on which the reinforcing portion 16 is disposed may be polished such that, for example, the maximum height roughness Rz is reduced.

As shown in FIGS. 1 and 5, a plurality of terminals 19 are disposed on the upper and lower surfaces of the left end of the casing 12. The above-described electrodes 21a, 21b, 24a, 24b, 32, 34, 42, and 44 are electrically connected to their respective terminals 19 through wiring lines disposed in the casing 12. Similarly, the heater electrode 62 is electrically connected to two terminals 19 through wiring lines. For example, the wiring lines are disposed on the upper and lower surfaces of the first to eleventh layers 14a to 14k or disposed in through holes provided in the first to eleventh layers 14a to 14k. Although not illustrated in FIG. 2, the power sources 29, 39, 49, and 69 and the ammeter 52 are electrically connected to the respective electrodes in the particle detection element 11 through the terminals 19.

A method for producing the thus-configured particle detection element 11 will be described below. First, a plurality of unfired ceramic green sheets containing a ceramic raw material powder and corresponding to the first to eleventh layers 14a to 14k are prepared. Through holes and a space serving as the gas flow passage 13 are formed by, for example, punching in advance in each of the green sheets corresponding to the fourth to eighth layers 14d to 14h. Next, pattern printing processing for forming various patterns on the ceramic green sheets corresponding to the first to eleventh layers 14a to 14k and drying processing are performed. Specifically, the patterns to be formed are, for example, patterns for the electrodes, the wiring lines connected to the electrodes, the terminals 19, etc. The patterns are printed by applying a pattern forming paste to the green sheets using a known screen printing technique. During, before, and after the pattern printing processing, the through holes are filled with a conductive paste that later becomes wiring lines. Subsequently, printing processing for printing a bonding paste for laminating and bonding the green sheets and drying processing are performed. The green sheets with the bonding paste formed thereon are stacked in a prescribed order, and compression-bonding processing for forming one layered body is performed. Specifically, prescribed temperature-pressure conditions are applied to compression-bond the green sheets. When the compression-bonding processing is performed, a vanishing material (e.g., theobromine) that vanishes during firing is filled into the space that later becomes the gas flow passage 13 in advance. Then the layered body is cut to obtain a layered body having the size of the casing 12. Then the cut layered body is fired at a prescribed firing temperature. Since the vanishing material vanishes during firing, the portion filled with the vanishing material forms the gas flow passage 13. The particle detection element 11 is thereby obtained.

In the process for producing the particle detection element 11, the reinforcing portion 16 can be formed as follows. For example, when the green sheets for the fourth wall 15d are formed, the reinforcing portion 16 may be formed by using a die that allows the fourth wall 15d to be formed into a shape having the reinforcing portion 16. Alternatively, the reinforcing portion 16 may be formed by additionally printing a pattern for the reinforcing portion 16 on part of a formed green sheet to increase the thickness of the green sheet.

The casing 12 formed of the ceramic material described above is preferable because the following effects are obtained. Generally, the ceramic material has high heat resistance and can easily withstand the temperature at which the particles 17 are removed using the heater electrode 62 as described later, e.g., a high temperature of 600° C. to 800° C. at which carbon, which is the main component of the particles 17, burns. Moreover, since the ceramic material generally has a high Young's modulus, the stiffness of the casing 12 can be easily maintained even when the walls and partitions of the casing 12 are thin, and therefore the deformation of the casing 12 caused by a thermal shock or an external force can be prevented. Since the deformation of the casing 12 is prevented, a reduction in the accuracy of detection of the number of particles due to, for example, a change in the electric field distribution in the gas flow passage 13 during discharge of the electric charge generator 20 or a change in the thicknesses (vertical heights) of the branched flow passages 13b to 13d can be prevented. Therefore, by forming the casing 12 using the ceramic material, the thicknesses of the walls and partitions of the casing 12 can be reduced to make the casing 12 more compact while the deformation of the casing 12 is prevented. No particular limitation is imposed on the ceramic material. Examples of the ceramic material include alumina, silicon nitride, mullite, cordierite, magnesia, and zirconia.

Next, an example of the use of the particle detector 10 will be described. When particles contained in exhaust gas from an automobile is measured, the particle detection element 11 is installed inside the exhaust pipe of the engine. In this case, the particle detection element 11 is installed such that the exhaust gas is introduced into the casing 12 from the gas inlet 13a, passes through the branched flow passages 13b to 13d, and is then discharged. The power sources 29, 39, 49, and 69 and the detector 50 are connected to the particle detection element 11.

The particles 17 contained in the exhaust gas introduced into the casing 12 from the gas inlet 13a are charged by the charges 18 (positive charges in this case) generated by discharge in the electric charge generator 20 and form charged particles P. In the excess electric charge removing unit 30, the electric field is weak, and the length of the removing electrode 34 is shorter than the length of the collecting electrodes 42. Therefore, the charged particles P pass through the excess electric charge removing unit 30 without any change, flow into any of the branched flow passages 13b to 13d, and reach the collector 40. The charges 18 not imparted to the particles 17 are attracted to the removing electrode 34 of the excess electric charge removing unit 30 even though the electric field is weak and are discarded to the GND through the removing electrode 34. Therefore, almost no unnecessary charges 18 not imparted to the particles 17 reach the collector 40.

The charged particles P that have reached the collector 40 are collected by any of the first to third collecting electrodes 42a to 42c through the electric field generated by the electric field generating electrodes 44. A current corresponding to the charges 18 on the charged particles P adhering to the collecting electrodes 42 is measured by the ammeter 52, and the arithmetic unit 54 computes the number of particles 17 based on the current. In the present embodiment, the first to third collecting electrodes 42a to 42c are connected to one ammeter 52, and the current corresponding to the total number of charges 18 on the charged particles P adhering to the first to third collecting electrodes 42a to 42c is measured by the ammeter 52. The relation between the current I and the amount of charges q is I=dq/(dt), q=∫Idt. The arithmetic unit 54 integrates (accumulates) the current value over a prescribed period to obtain the integrated value (accumulated charge amount), divides the accumulated charge amount by the elementary charge to determine the total number of charges (the number of collected charges), and divides the number of collected charges by the average number of charges (average charge number) imparted to one particle 17 to determine the number Nt of particles 17 adhering to the collecting electrodes 42. The arithmetic unit 54 detects the number Nt as the number of particles 17 in the exhaust gas. However, part of the particles 17 may pass through without being collected by the collecting electrodes 42 or may adhere to the inner circumferential surface of the casing 12 before collected by the collecting electrodes 42. Therefore, the collection ratio of particles 17 may be determined in advance in consideration of the ratio of particles 17 not collected by the collecting electrodes 42, and the arithmetic unit 54 may detect the total number Na, which is the value obtained by dividing the number Nt by the collection ratio, as the number of particles 17 in the exhaust gas.

When a large number of particles 17 etc. accumulate on the collecting electrodes 42, additional charged particles P may no longer be collected by the collecting electrodes 42. Therefore, by heating the collecting electrodes 42 by the heater electrode 62 periodically or at the time when the amount of accumulation reaches a prescribed amount, the accumulated materials on the collecting electrodes 42 are heated by the heater electrode 62 to incinerate the accumulated materials to thereby refresh the electrode surfaces of the collecting electrodes 42. Moreover, the heater electrode 62 may be used to burn the particles 17 adhering to the inner circumferential surface of the casing 12.

When the particle detection element 11 detects the number of particles in high-temperature exhaust gas, thermal shock may be applied to the casing 12 due to adhesion of water, or an external force may be applied to the casing 12 due to, for example, vibrations of the car to which the particle detection element 11 is attached. Generally, when the casing 12 is deformed due to thermal shock or external force, the electric field distribution in the gas flow passage 13 during discharge of the electric charge generator 20 may be changed, and the number of generated charges 18 and the spatial distribution of charges 18 may be changed. When these changes occur, the number of charges 18 adhering to one particle 17 changes, and this causes a reduction in the accuracy of detection of the number of particles. However, in the particle detection element 11 in the present embodiment, since the casing 12 has the reinforcing portion 16 on its outer circumferential surface, the reinforcing portion 16 functions as a rib, and the stiffness of the casing 12 thereby increases. This can suppress the deformation of the casing 12 of the particle detection element 11, and a reduction in the detection accuracy can be prevented. In the present embodiment, the deformation of the fourth wall 15d with the reinforcing portion 16 disposed thereon is particularly suppressed.

The correspondence between the components in the present embodiment and the components in the present invention will be explained. The casing 12 in the present embodiment corresponds to the casing in the present invention, and the electric charge generator 20 corresponds to the electric charge generating unit. The collector 40 corresponds to the collecting unit, and the reinforcing portion 16 corresponds to the reinforcing portion. The second and third walls 15b and 15c correspond to the partition, and the detector 50 corresponds to the detection unit.

In the particle detection element 11 in the present embodiment described above in detail, since the casing 12 has the reinforcing portion 16 on its outer circumferential surface, the stiffness of the casing 12 is high, and deformation of the casing 12 is suppressed, so that a reduction in the measurement accuracy can be prevented.

The casing 12 has the second and third walls 15b and 15c serving as partitions that partition the gas flow passage 13 into the branched flow passages 13b to 13d. The collector 40 includes the collecting electrodes 42 disposed in the respective branched flow passages 13b to 13d. In this case, since the second and third walls 15b and 15c serve as support members that support the casing 12 from the inside, the deformation of the casing 12 can be more effectively suppressed by the reinforcing portion 16 and the second and third walls 15b and 15c. The collecting electrodes 42 are disposed in the respective branched flow passages 13b to 13d. Therefore, even when the charged particles P reach any of the branched flow passages 13b to 13d, the charged particles P can be collected by the collecting electrodes 42.

The casing 12 further includes the heater electrode 62 embedded in the casing 12 and heats the casing 12, and the reinforcing portion 16 is disposed such that the portion of the fourth wall 15d in which the heater electrode 62 is embedded is partially thickened. In this case, by causing the heater electrode 62 to generate heat, particles 17 adhering to, for example, the inner circumferential surface of the casing 12 and the collecting electrodes 42 can be burnt, and the particle detection element 11 can be refreshed. Moreover, since the reinforcing portion 16 is disposed such that the portion of the fourth wall 15d in which the heater electrode 62 is embedded is thickened, the heat capacity of a portion around the heater electrode in the casing is increased. Therefore, changes in temperature of the heater electrode 62 due to the fluid (e.g., exhaust gas) in contact with the casing 12 are reduced. For example, when the arithmetic unit 54 measures the resistance value of the heater electrode 62 and controls the heater power source 69 to perform feedback control of the temperature of the heater electrode 62, the temperature of the heater power source 69 is easily stabilized at around a target value.

Moreover, the casing 12 includes, as its walls: long wall portions (the first to fourth walls 15a to 15d in this case) in which a portion of the inner circumferential surface that appears in a cross section perpendicular to the center axis of the gas flow passage 13 has a long length; and short wall portions (the left and right walls of the gas flow passage 13 in this case) in which a portion of the inner circumferential surface that appears in the above cross section has a short length. The reinforcing portion 16 is disposed on the fourth wall 15d, which is one of the long wall portions. Generally, the long wall portions are more likely to deform than the short wall portions. Therefore, the presence of the reinforcing portion 16 on the fourth wall 15d, which is one of the long wall portions, can more effectively suppress the deformation of the casing 12.

Moreover, since the collector 40 includes the electric field generating electrodes 44 that generate an electric field that causes the charged particles P to move toward the collecting electrodes 42, the charged particles P can be collected by the collecting electrodes 42 more reliably.

Moreover, since the heater electrode 62 is embedded in the casing 12, a short circuit between the heater electrode 62 and an external circuit of the particle detection element 11 can be more effectively prevented as compared with the case where the heater electrode 62 is exposed at the outer surface of the casing 12.

The present invention is not limited to the embodiment described above. It will be appreciated that the present invention can be embodied in various forms so long as they fall within the technical scope of the invention.

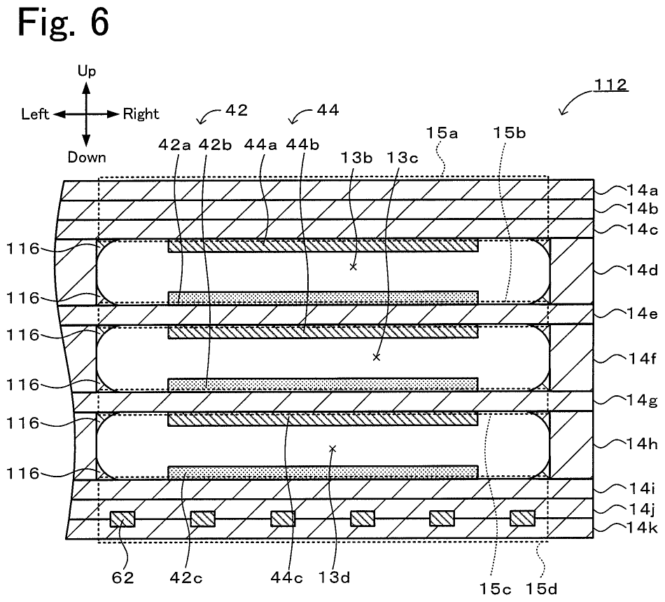

For example, in the above embodiment, the reinforcing portion 16 is disposed on the fourth wall 15d. The reinforcing portion may have any shape and may be freely disposed, so long as the casing 12 can be reinforced by thickening a wall of the casing 12 partially. For example, the reinforcing portion 16 may be disposed on the fourth wall 15d irrespective of the shape of the heater electrode 62. Another reinforcing portion 16 may be further disposed on at least one of the first to third walls 15a to 15c. A reinforcing portion 16 may be disposed on each of the long wall portions (for example, the first to fourth walls 15a to 15d). The reinforcing portion 16 may be disposed only on the outer circumferential surface of the casing 12 but may be disposed on at least one of the outer circumferential surface and the inner circumferential surface. FIG. 6 is a cross-sectional view of a casing 112 in a modification. The casing 112 has reinforcing portions 116 disposed on its inner circumferential surface. The reinforcing portions 116 are disposed on the inner circumferential surface and located at the four corners of each of the branched flow passages 13b to 13d when the casing is viewed in a cross section perpendicular to the center axis, and the walls of the casing 112 are thereby partially thickened. The reinforcing portions 116 thicken connection portions between the upper and lower walls and the left and right walls. The reinforcing portions 116 can be regarded as thickening the upper and lower walls (the first to fourth walls 15a to 15d in this case) and also regarded as thickening the left and right walls. In a cross section perpendicular to the center axis of the gas flow passage 13 (each of the branched flow passages 13b to 13d in this case), the casing 112 has a shape in which the corners of each rectangle along the inner circumferential surface are reinforced because of the presence of the reinforcing portions 116. In the casing 112 in this modification, since the corners of the inner circumferential surface on which stress tends to be concentrated are reinforced by the reinforcing portions 116, the deformation of the casing 112 is suppressed. The casing may include the reinforcing portion 16 in FIG. 3 and also the reinforcing portions 116 in FIG. 6.

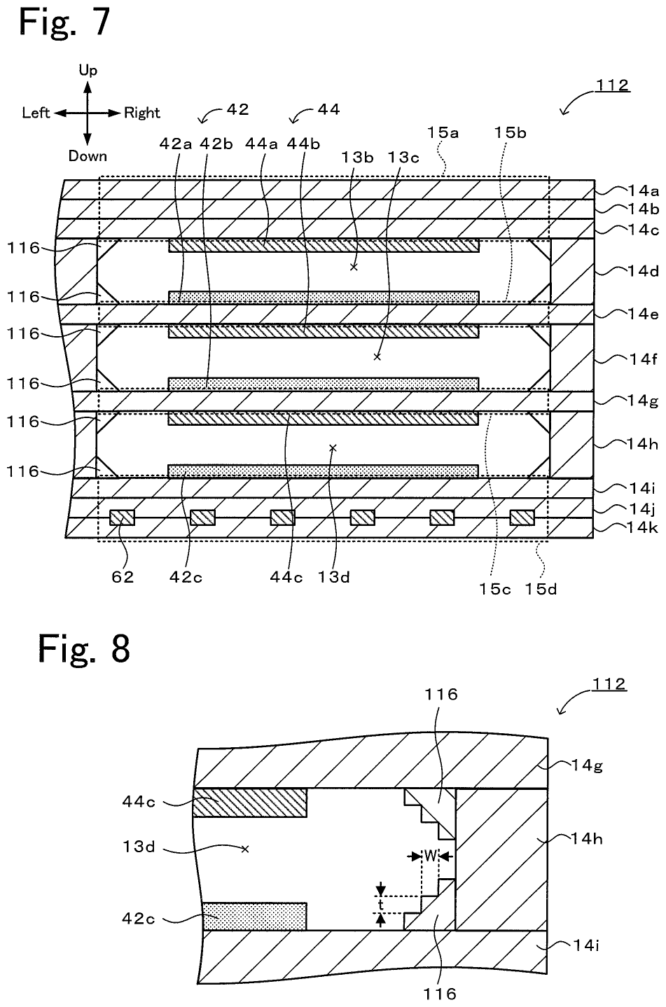

In the reinforcing portions 116 in FIG. 6, portions facing the gas flow passage 13 are curved surfaces as illustrated. Therefore, rising portions connecting the upper and lower surfaces of the branched flow passages 13b to 13d to the left and right surfaces are smooth. When the reinforcing portions 116 have such a shape, the corners of the rectangles along the inner circumferential surface of the casing 112 in a cross section perpendicular to the center axis of the gas flow passage 13 are rounded, so that stress concentration on the corners can be prevented. Portions of the reinforcing portions 116 that face the gas flow passage 13 may be flat. Specifically, in a cross section perpendicular to the center axis of the gas flow passage 13, portions of the reinforcing portions 116 that face the gas flow passage 13 may be linear. For example, when all the reinforcing portions 116 shown in FIG. 6 have such a shape, the inner circumferential surface of the casing 112 has a shape similar to a polygonal shape (an octagonal shape in this case) in a cross section perpendicular to the center axis of the gas flow passage 13, as shown in FIG. 7. In this case also, the corners of the rectangles along the inner circumferential surface of the casing 112 are reinforced, and therefore the deformation of the casing 112 can be suppressed.

A particle detection element 11 including the reinforcing portions 116 shown in FIG. 6 can be produced, for example, by the following procedure. First, the casing 112 with no reinforcing portions 116 is produced using the above-described production method. The casing 112 has been fired, and the electrodes such as the collecting electrodes 42 and the electric field generating electrodes 44 have already been provided. Next, a jig is fixed to the casing 112, and wires are disposed so as to pass through the gas flow passage 13 in the front-back direction. In this case, the wires selected may be wires generally used for a wire electric discharge machine or a wire saw. The wires are used to grind the fourth, sixth, eighth layers 14d, 14f, and 14h in the left-right direction so as to enlarge the gas flow passage 13, and the reinforcing portions 116 having a radius of curvature determined by the diameter of the wires can thereby be formed. In this case, the casing 112 with no reinforcing portions 116 formed is formed such that the flow channel width of the gas flow passage 13 is reduced in advance by an amount corresponding to the width to be ground. The casing 112 including the reinforcing portions 116 shown in FIG. 7 can be produced similarly. Specifically, while the diameter of the wires and the manner of grinding using the wires are appropriately adjusted, the inner circumferential surface of the casing 12 is ground such that the reinforcing portions 116 remain. When the wires are used to grind the casing 12 so as to enlarge the gas flow passage 13, it is preferable that wiring lines for the electrodes, such as the collecting electrodes 42, exposed to the gas flow passage 13 are not disposed on the inner circumferential surface of the gas flow passage 13 so that the wiring lines are not ground. For example, the wiring lines may be disposed in through holes formed on the back side of the electrodes such that the wiring lines are routed to the terminals 19 without extending along the inner circumferential surface of the gas flow passage 13.

The particle detection element 11 including any of the reinforcing portions 116 shown in FIGS. 6 and 7 may also be produced by adding the step of subjecting the green sheets corresponding to the first to eleventh layers 14a to 14k to pressing using a die to the step of stacking the green sheets in the above-described production method. For example, the formation of reinforcing portions 116 directly above the ninth layer 14i in FIG. 6 will be described. Suppose that, in the process of stacking the green sheets, green sheets corresponding to the ninth to eleventh layers 14i to 14k in FIG. 6 have been stacked. At this point, the patterns corresponding to the electrodes 21b, 34, and 42c have already been formed on the green sheet corresponding to the ninth layer 14i and dried. Next, a green sheet corresponding to the lowermost one of a plurality of layers forming the eighth layer 14h (in which the space corresponding to the branched flow passage 13d has been punched in advance) is stacked on the green sheet corresponding to the eleventh layer 14i. Then a die having the shapes of the reinforcing portions 116 on an end face is used to press edge portions of the green sheet corresponding to the lowermost layer of the eighth layer 14h, and the shapes of the reinforcing portions 116 can thereby be formed. The reinforcing portions 116 at other positions can be similarly formed using the die in the step of stacking the green sheets. All the green sheets corresponding the first to eleventh layers 14a to 14k are stacked while the reinforcing portions 116 are formed as described above, and then the layered body is fired. In this manner, the casing 112 having the reinforcing portions 116 is obtained.

The reinforcing portions 116 provided at the corners of the inner circumferential surface of the gas flow passage 13 shown in FIGS. 6 and 7 may be formed as stepped portions as shown in FIG. 8. The height t of the steps of the reinforcing portions 116 in FIG. 8 in the vertical direction (the stacking direction of the layers of the casing 12) may be 0.005 mm or more and 0.3 mm or less. The width W of the steps of the reinforcing portions 116 in FIG. 8 in the left-right direction may be 0.01 mm or more and 0.5 mm or less. The reinforcing portions 116 having the shape in FIG. 8 may be formed using the above method using the die or formed by stacking green sheets corresponding to the respective steps.

In the above embodiment, a cross section of the gas flow passage 13 that is perpendicular to the center axis has a substantially rectangular shape, but this is not a limitation. The cross section may have a circular (perfect circular) shape, an elliptical shape, or a polygonal shape other than the rectangular shape. Similarly, the outer shape of the casing 12 in a cross section perpendicular to the center axis of the gas flow passage 13 may be a shape other than the rectangular shape.

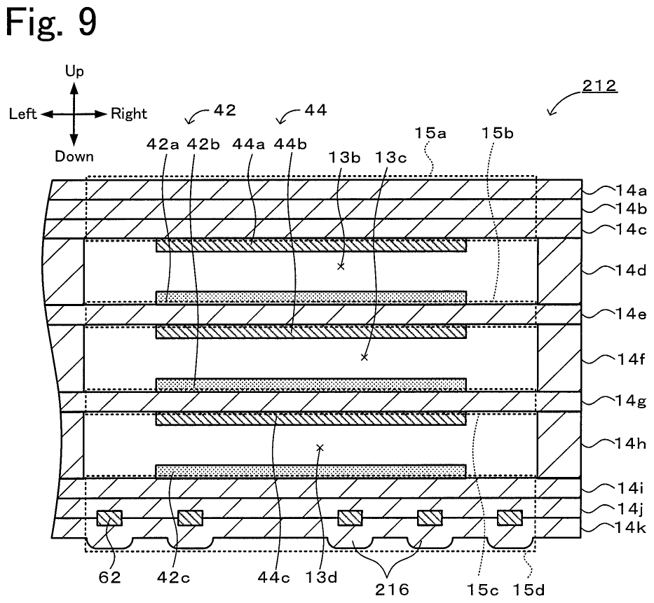

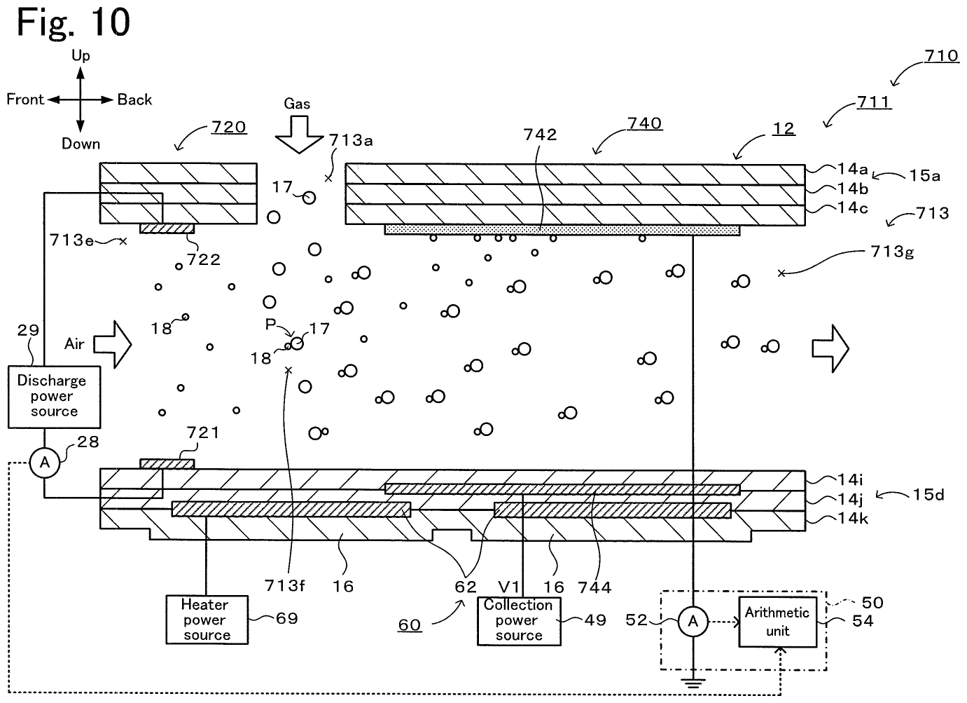

In the above embodiment, as shown in FIGS. 2 and 3, edge portions of the reinforcing portion 16 that protrude from the fourth wall 15d (e.g., the lower right edge and lower left edge of the reinforcing portion 16 in FIG. 2) are sharp corners, but this is not a limitation. For example, as shown in a casing 212 in a modification in FIG. 9, edge portions of a reinforcing portion 216 that protrude from the fourth wall 15d may have a curved cross-sectional shape.

In the above embodiment, the casing 12 includes the second and third walls 15b and 15c as two partitions. However, the number of partitions may be one or three or more. The casing 12 may have no partition.

In the above embodiment, the electric field generating electrodes 44 are exposed to the gas flow passage 13, but this is not a limitation. The electric field generating electrodes 44 may be embedded in the casing 12. Instead of the first electric field generating electrode 44a, a pair of electric field generating electrodes may be provided in the casing 12 so as to vertically sandwich the first collecting electrode 42a therebetween, and the charged particles P may be moved toward the first collecting electrode 42a through an electric field generated by a voltage applied between the pair of electric field generating electrodes. This also applies to the second to third electric field generating electrodes 44b to 44c.

In the above embodiment, each of the collecting electrodes 42 faces a corresponding one of the electric field generating electrodes 44, but this is not a limitation. For example, the number of electric field generating electrodes 44 may be smaller than the number of collecting electrodes 42. For example, the second and third electric field generating electrodes 44b and 44c in FIG. 2 may be omitted, and the charged particles P may be moved toward the first to third collecting electrodes 42a to 42c through the electric field generated by the first electric field generating electrode 44a. Each of the first to third electric field generating electrodes 44a to 44c causes the charged particles P to move downward, but this is not a limitation. For example, the first collecting electrode 42a and the first electric field generating electrode 44a in FIG. 2 may be arranged in reverse.

In the above embodiment, the first to third collecting electrodes 42a to 42c are connected to one ammeter 52, but this is not a limitation. The first to third collecting electrodes 42a to 42c may be connected to respective ammeters 52. In this manner, the arithmetic unit 54 can compute the numbers of particles 17 adhering to the first to third collecting electrodes 42a to 42c separately. In this case, for example, by applying different voltages to the first to third electric field generating electrodes 44a to 44c or using branched flow passages 13b to 13d having different passage thickness (the vertical heights in FIGS. 2 and 3), the first to third collecting electrodes 42a to 42c can collect particles 17 having respective different particle diameters.

In the above embodiment, the voltage V1 is applied to the first to third electric field generating electrodes 44a to 44c, but no voltage may be applied thereto. Even when the electric field generating electrodes 44 generate no electric field, if the passage thickness of the branched flow passages 13b to 13d is set to a very small value (e.g., 0.01 mm or more and less than 0.2 mm), charged particles P having a relatively small diameter under strong Brownian motion can be caused to collide with the collecting electrodes 42. The collecting electrodes 42 can thereby collect the charged particles P. In this case, the particle detection element 11 may not include the electric field generating electrodes 44.

In the above embodiment, one of the first and second electric charge generators 20a and 20b may be omitted. The ground electrodes 24a and 24b are embedded in the casing 12. However, when a dielectric layer is present between a discharge electrode and an ground electrode, the ground electrode may be exposed to the gas flow passage 13. In the above embodiment, the electric charge generator 20 used includes the discharge electrodes 21a and 21b and the ground electrodes 24a and 24b, but this is not a limitation. For example, an electric charge generator including a needle-shaped electrode and a counter electrode disposed so as to face the needle-shaped electrode with the gas flow passage 13 interposed therebetween may be employed. In this case, when a high voltage (for example, a DC voltage or a high-frequency pulse voltage) is applied between the needle-shaped electrode and the counter electrode, an aerial discharge (corona discharge in this case) occurs due to the potential difference between the two electrodes. When the gas passes through the aerial discharge, charges 18 are imparted to the particles 17 in the gas to form charged particles P, as in the above embodiment. For example, the needle-shaped electrode may be disposed on one of the first and fourth walls 15a and 15d, and the counter electrode may be disposed on the other one.

In the above embodiment, the collecting electrodes 42 are disposed on the downstream side of the electric charge generator 20 with respect to the gas flow within the casing 12, and the gas containing the particles 17 is introduced into the casing 12 from the upstream side of the charge generating element 20. However, this structure is not a limitation. In the above embodiment, the collection target of the collecting electrodes 42 is the charged particles P, but the collection target may be charges 18 not imparted to the particles 17. For example, a particle detection element 711 in a modification shown in FIG. 10 and a structure of a particle detector 710 including the particle detection element 711 may be employed. The particle detection element 711 does not include the excess electric charge removing unit 30 and includes an electric charge generator 720, a collector 740, and a gas flow passage 713 instead of the electric charge generator 20, the collector 40, and the gas flow passage 13. The casing 12 of the particle detection element 711 does not include the partitions. The electric charge generator 720 includes a discharge electrode 721 and a counter electrode 722 disposed so as to face the discharge electrode 721. A high voltage is applied between the discharge electrode 721 and the counter electrode 722 from the discharge power source 29. The particle detector 710 includes an ammeter 28 that measures a current when the discharge power source 29 applies the voltage. The collector 740 includes: a collecting electrode 742 disposed on the inner circumferential surface of the gas flow passage 713 of the casing 12 on the same side as the side on which the counter electrode 722 is disposed (the upper side in this case); and an electric field generating electrode 744 embedded in the casing 12 and disposed below the collecting electrode 742. The collecting electrode 742 is connected to the detector 50, and the electric field generating electrode 744 is connected to the collection power source 49. The potential of the counter electrode 722 may be the same as the potential of the collecting electrode 742. The gas flow passage 713 includes an air inlet 713e, a gas inlet 713a, a mixing region 713f, and a gas outlet 713g. The air inlet 713e introduces a gas (air in this case) containing no particles 17 into the casing 12 such that the gas passes through the electric charge generator 20. The gas inlet 713a introduces a gas containing the particles 17 into the casing 12 such that the gas does not pass through the electric charge generator 20. The mixing region 713f is disposed downstream of the electric charge generator 720 but upstream of the collector 740, and the air from the air inlet 713e and the gas from the gas inlet 713a are mixed in the mixing region 713f. The gas outlet 713g discharges the gas passing through the mixing region 713f and the collector 740 to the outside of the casing 12. In this particle detector 710, the size of the collecting electrode 742 and the intensity of the electric field on the collecting electrode 742 (i.e., the magnitude of the voltage V1) are set such that the charged particles P are discharged from the gas outlet 713g without being collected by the collecting electrode 742 and that charges 18 not imparted to the particles 17 are collected by the collecting electrode 742.

In the thus-configured particle detector 710 in FIG. 10, when the discharge power source 29 applies a voltage between the discharge electrode 721 and the counter electrode 722 such that the discharge electrode 721 side has a higher potential, an aerial discharge occurs in the vicinity of the discharge electrode 721. In this case, charges 18 are generated in air between the discharge electrode 721 and the counter electrode 722 and imparted to the particles 17 in the gas within the mixing region 713f. Therefore, although the gas containing the particles 17 does not pass through the electric charge generator 720, the electric charge generator 720 can convert the particles 17 to the charged particles P, as does the electric charge generator 20. The casing 12 has the reinforcing portion 16 on the outer circumferential surface, as in the above embodiment. Therefore, the stiffness of the casing 12 is high, and the deformation of the casing 12 is suppressed, so that a change in the number of charges 18 generated in the electric charge generator 720 and a change in the spatial distribution of the charges 18 can be prevented.

In the particle detector 710 in FIG. 10, the voltage V1 applied by the collection power source 49 causes an electric field directed from the electric field generating electrode 744 toward the collecting electrode 742 to be generated, and the collecting electrode 742 thereby collects the collection target (the charges 18 not imparted to the particles 17 in this case). The charged particles P are not collected by the collecting electrode 742 and are discharged from the gas outlet 713g. The arithmetic unit 54 obtains, as an input, the current value based on the charges 18 collected by the collecting electrode 742 from the ammeter 52 and detects the number of particles 17 in the gas based on the input current value. For example, the arithmetic unit 54 determines the number of charges 18 (the number of transmitted charges) transmitted through the gas flow passage 13 without being collected by the collecting electrode 742 by deriving the current difference between a current value measured by the ammeter 28 and a current value measured by the ammeter 52 and dividing the derived current difference value by the elementary charge. Then the arithmetic unit 54 computes the number Nt of particles 17 in the gas by dividing the number of transmitted charges by the average number of charges 18 (the average charge number) imparted to one particle 17. Even when the collection target of the collecting electrode 742 is not the charged particles P but the charges 18 not imparted to the particles 17 as described above, the number of particles 17 in the gas can be detected using the particle detection element 711 because there is a correlation between the number of collection target objects collected by the collecting electrode 742 and the number of particles 17 in the gas.

In the particle detection element 711 in FIG. 10, the collection ratio of charges 18 may be determined in advance in consideration of the ratio of the charges 18 not collected by the collecting electrode 742 among the charges 18 not imparted to the particles 17. In this case, the arithmetic unit 54 may derive the current difference by subtracting a value obtained by dividing the current value measured by the ammeter 52 by the collection ratio from the current value measured by the ammeter 28. The particle detector 710 may not include the ammeter 28. In this case, for example, the arithmetic unit 54 adjusts the voltage applied from the discharge power source 29 such that a prescribed number of charges 18 are generated per unit time. The arithmetic unit 54 derives the current difference between a prescribed current value (the current value corresponding to the prescribed number of charges 18 generated by the electric charge generator 720) and the current value measured by the ammeter 52.

In the above embodiment, the detector 50 detects the number of particles 17 in the gas, but this is not a limitation. The detector 50 may detect the particles 17 in the gas. For example, the detector 50 may not detect the number of particles 17 in the gas but may detect the amount of the particles 17 in the gas. Examples of the amount of the particles 17 include, in addition to the number of particles 17, the mass of the particles 17, and the surface area of the particles 17. When the detector 50 detects the mass of the particles 17 in the gas, the arithmetic unit 54 may determine the mass of the particles 17 in the gas, for example, by multiplying the number Nt of particles 17 by the mass (e.g., the average mass) of one particle 17. Alternatively, the relation between the amount of accumulated charges and the total mass of collected charged particles P may be stored as a map in the arithmetic unit 54 in advance, and the arithmetic unit 54 may directly derive the mass of the particles 17 in the gas from the amount of accumulated charges using the map. When the arithmetic unit 54 determines the surface area of the particles 17 in the gas, a method similar to the method for determining the mass of the particles 17 in the gas may be used. When the collection target of the collecting electrodes 42 is charges 18 not imparted to the particles 17, the detector 50 can detect the mass or surface area of the particles 17 using a similar method.

In the description of the above embodiment, the number of positively charged particles P is measured. However, the number of particles 17 can be measured in a similar manner when the charged particles P are negatively charged.

The present application claims priority from Japanese Patent Application No. 2017-171122 filed Sep. 6, 2017, the entire contents of which are incorporated herein by reference.

What is claimed is:

1. A particle detection element used to detect particles in a gas, the particle detection element comprising:
a casing having a gas flow passage through which the gas passes;
an electric charge generating unit that imparts charges generated by a discharge to the particles in the gas introduced into the casing to thereby form charged particles; and
a collecting unit including a collecting electrode that is disposed inside the casing and collects a collection target that is the charged particles or the charges not imparted to the particles,
wherein the casing includes a reinforcing portion on at least one of an outer circumferential surface and an inner circumferential surface of the casing, the reinforcing portion partially thickening a wall of the gas flow passage.

2. The particle detection element according to claim 1,
wherein the casing includes a partition that partitions the gas flow passage into a plurality of branched flow passages, and
the collecting unit includes a plurality of the collecting electrodes disposed in the respective branched flow passages.

3. The particle detection element according to claim 1,
wherein the casing includes a heater electrode that is embedded in the casing and heats the casing, and
the reinforcing portion is disposed such that a portion of the wall in which the heater electrode is embedded is partially thickened.

4. The particle detection element according to claim 1,
wherein the reinforcing portion is disposed on the inner circumferential surface of the casing, and
a cross section obtained by cutting the inner circumferential surface in a direction perpendicular to a center axis of the gas flow passage has a rectangular shape in which a corner of the rectangular shape is reinforced due to the presence of the reinforcing portion.

5. The particle detection element according to claim 1,
wherein the wall of the casing includes: a long wall portion in which a portion of the inner circumferential surface that appears in a cross section perpendicular to a center axis of the gas flow passage has a long length; and a short wall portion in which a portion of the inner circumferential surface that appears in the cross section has a short length, and
the reinforcing portion is disposed on the long wall portion.

6. A particle detector comprising:
the particle detection element according to claim 1; and
a detection unit that detects the particles based on a physical quantity that varies according to the collection target collected by the collecting electrode.
